(19) United States
(12) Patent Application Publication
(10) Pub. No.: US 2021/0266666 A1
(43) Pub. Date: Aug. 26, 2021

(54) METHOD AND APPARATUS FOR A CAMERA DRIVEN AUDIO EQUALIZATION OF PLAYBACK IN A COMMUNICATION DEVICE

(71) Applicant: Facebook, Inc., Menlo Park, CA (US)

(72) Inventors: Plamen Alexandrov Ivanov, Mountain View, CA (US); Jens Nilsson, Foster City, CA (US)

(21) Appl. No.: 16/801,053

(22) Filed: Feb. 25, 2020

(51) Int. Cl. H04R 3/04; G06T 7/70; G06F 1/03; G06F 3/01

(52) U.S. Cl. CPC H04R 3/04; G06T 7/70; G06F 3/017; G06F 3/011; G06F 1/03

(57) ABSTRACT

A method of performing equalization of audio signals to be provided to the speakers of a client device is based on determining a target position for the client device in the environment. Sensors in the client device may capture data of the environment. The sensor data is analyzed to determine location information associated with one or more target individuals in the environment. Audio signals that are to be provided to an audio output system of the client device are equalized based on the target position to compensate for an expected loss in the audio signal between the client device and the determined target position. The equalized audio signals are provided to the speakers of the client device for audio playback.

### BACKGROUND

With growing popularity of voice controlled devices and voice communication devices (e.g., smart phones, smart home devices), accurate audio playback is an important application. For communication devices to provide hand-free operation while being located far field within an environment, maintaining good audio quality of any reproduced audio for a target user is desired. However, the audio playback quality may suffer from factors such as directional device response that arises from the acoustics of the device itself, influence of device placement, and the environment as a target user moves around the space. There is a need for providing high quality audio playback to a target user in communication devices that are located far field within the environment.

### SUMMARY

This disclosure relates generally to maintaining audio quality in audio playback by a client device, and more specifically to utilizing location information of target individuals within an environment to process audio signals that are subsequently provided for playback.

Embodiments relate to equalizing an audio signal that is to be provided to an audio output system of a client device based on locations of one or more target individuals within the environment. An audio signal intended for audio playback is received along with locations of one or more target individuals. A target position is determined based on the received locations of the one or more target individuals. Equalization parameters of an equalization function are determined based on the target position. The equalization function, based on the determined equalization parameters, is subsequently applied to audio signals to generate an equalized audio signal for audio playback, and provided to an audio output system of the client device.

The locations of the one or more target individuals are based on sensor data that is received from one or more sensors of the client device. The locations include a distance of each of the one or more target individuals from the client device, and an azimuthal angle made by each of the one or more target individuals with respect to a reference listening direction for the client device. In some embodiments, the target position is determined as a weighted combination of the received distances and azimuthal angles of each of the one or more target individuals. In some embodiments, the equalization parameters are retrieved based on the target position from stored one or more look-up tables that provide a frequency-dependent mapping of target positions to the equalization parameters. The equalization function is applied to the received audio signal to generate the equalized audio signal by computing a frequency-dependent complex gain function based on the determined equalization parameters, and applying the frequency-dependent complex gain function to the received audio signal to compensate for an expected loss in the audio signal between the client device and the determined target position.

### BRIEF DESCRIPTION OF THE DRAWINGS

FIG. 1 is a block diagram of a system environment for a communication system, in accordance with an embodiment.

FIG. 2 is a block diagram of an audio equalization module, in accordance with an embodiment.

FIG. 3 is a flowchart illustrating a process for performing audio equalization at a client device, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

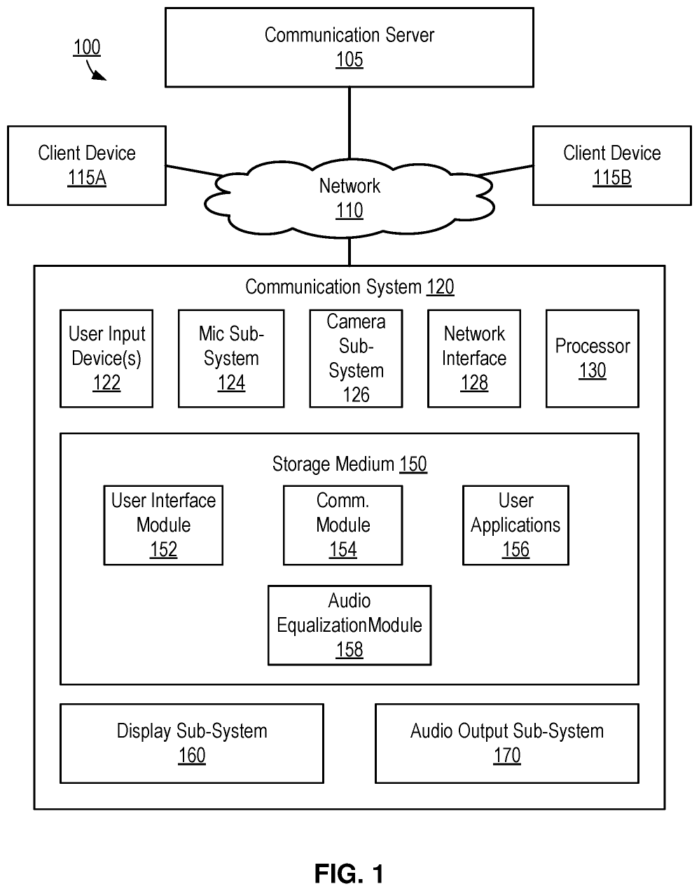

FIG. 1 is a block diagram of a system environment 100 for a communication system 120. The system environment 100 includes a communication server 105, one or more client devices 115 (e.g., client devices 115A, 115B), a network 110, and a communication system 120. In alternative configurations, different and/or additional components may be included in the system environment 100. For example, the system environment 100 may include additional client devices 115, additional communication servers 105, or additional communication systems 120.

In an embodiment, the communication system 120 comprises an integrated computing device that operates as a standalone network-enabled device. In another embodiment, the communication system 120 comprises a computing device for coupling to an external media device such as a television or other external display and/or audio output system. In this embodiment, the communication system may couple to the external media device via a wireless interface or wired interface (e.g., an HDMI cable) and may utilize various functions of the external media device such as its display, speakers, and input devices. Here, the communication system 120 may be configured to be compatible with a generic external media device that does not have specialized software, firmware, or hardware specifically for interacting with the communication system 120.

The client devices 115 are one or more computing devices capable of receiving user input as well as transmitting and/or receiving data via the network 110. In one embodiment, a client device 115 is a conventional computer system, such as a desktop or a laptop computer. Alternatively, a client device 115 may be a device having computer functionality, such as a personal digital assistant (PDA), a mobile telephone, a smartphone, a tablet, an Internet of Things (IoT) device, a video conferencing device, another instance of the communication system 120, or another suitable device. A client device 115 is configured to communicate via the network 110. In one embodiment, a client device 115 executes an application allowing a user of the client device 115 to interact with the communication system 120 by enabling voice calls, video calls, data sharing, or other interactions. For example, a client device 115 executes a browser application to enable interactions between the client device 115 and the communication system 105 via the network 110. In another embodiment, a client device 115 interacts with the communication system 105 through an application running on a native operating system of the client device 115, such as IOS® or ANDROID™.

The communication server 105 facilitates communications of the client devices 115 and the communication system 120 over the network 110. For example, the communication server 105 may facilitate connections between the communication system 120 and a client device 115 when a voice or video call is requested. Additionally, the communication server 105 may control access of the communication system 120 to various external applications or services available over the network 110. In an embodiment, the communication server 105 may provide updates to the communication system 120 when new versions of software or firmware become available. In other embodiments, various functions described below as being attributed to the communication system 120 can instead be performed entirely or in part on the communication server 105. For example, in some embodiments, various processing or storage tasks may be offloaded from the communication system 120 and instead performed on the communication server 105.

The network 110 may comprise any combination of local area and/or wide area networks, using wired and/or wireless communication systems. In one embodiment, the network 110 uses standard communications technologies and/or protocols. For example, the network 110 includes communication links using technologies such as Ethernet, 802.11 (WiFi), worldwide interoperability for microwave access (WiMAX), 3G, 4G, 5G, code division multiple access (CDMA), digital subscriber line (DSL), Bluetooth, Near Field Communication (NFC), Universal Serial Bus (USB), or any combination of protocols. In some embodiments, all or some of the communication links of the network 110 may be encrypted using any suitable technique or techniques.

The communication system 120 includes one or more user input devices 122, a microphone sub-system 124, a camera sub-system 126, a network interface 128, a processor 130, a storage medium 150, a display sub-system 160, and an audio sub-system 170. In other embodiments, the communication system 120 may include additional, fewer, or different components.

The user input device 122 comprises hardware that enables a user to interact with the communication system 120. The user input device 122 can comprise, for example, a touchscreen interface, a game controller, a keyboard, a mouse, a joystick, a voice command controller, a gesture recognition controller, a remote control receiver, or other input device. In an embodiment, the user input device 122 may include a remote control device that is physically separate from the user input device 122 and interacts with a remote controller receiver (e.g., an infrared (IR) or other wireless receiver) that may integrated with or otherwise connected to the communication system 120. In some embodiments, the display sub-system 160 and the user input device 122 are integrated together, such as in a touchscreen interface. In other embodiments, user inputs may be received over the network 110 from a client device 115. For example, an application executing on a client device 115 may send commands over the network 110 to control the communication system 120 based on user interactions with the client device 115. In other embodiments, the user input device 122 may include a port (e.g., an HDMI port) connected to an external television that enables user inputs to be received from the television responsive to user interactions with an input device of the television. For example, the television may send user input commands to the communication system 120 via a Consumer Electronics Control (CEC) protocol based on user inputs received by the television.

The microphone sub-system 124 comprises one or more microphones (or connections to external microphones) that capture ambient audio signals by converting sound into electrical signals that can be stored or processed by other components of the communication system 120. The captured audio signals may be transmitted to the client devices 115 during an audio/video call or in an audio/video message. Additionally, the captured audio signals may be processed to identify voice commands for controlling functions of the communication system 120. In an embodiment, the microphone sub-system 124 comprises one or more integrated microphones. Alternatively, the microphone sub-system 124 may comprise an external microphone coupled to the communication system 120 via a communication link (e.g., the network 110 or other direct communication link). The microphone sub-system 124 may comprise a single microphone or an array of microphones. In the case of a microphone array, the microphone sub-system 124 may process audio signals from multiple microphones to generate one or more beamformed audio channels (or beams) each associated with a particular direction (or range of directions) in an environment surrounding the communication system 120.

The camera sub-system 126 comprises one or more cameras (or connections to one or more external cameras) that captures images and/or video signals. The captured images or video may be sent to the client device 115 during a video call or in a multimedia message, or may be stored or processed by other components of the communication system 120. Furthermore, in an embodiment, images or video from the camera sub-system 126 may be processed for object detection, human detection, face detection, face recognition, gesture recognition, or other information that may be utilized to control functions of the communication system 120. Here, an estimated position in three-dimensional space of a detected entity (e.g., a target listener) in an image frame may be outputted by the camera sub-system 126 in association with the image frame and may be utilized by other components of the communication system 120 as described below. In an embodiment, the camera sub-system 126 includes one or more wide-angle cameras for capturing a wide, panoramic, or spherical field of view of a surrounding environment. The camera sub-system 126 may include integrated processing to stitch together images from multiple cameras, or to perform image processing functions such as zooming, panning, de-warping, or other functions. In an embodiment, the camera sub-system 126 may include multiple cameras positioned to capture stereoscopic (e.g., three-dimensional images) or may include a depth camera to capture depth values for pixels in the captured images or video. The camera sub-system 126 may furthermore include a camera positioned to capture a time sequence of images. The camera sub-system 126 has a field-of-view based on characteristics of the one or more cameras, arrangement of the one or more cameras, position of the communication system 120 in the environment.

In some embodiments, the camera sub-system 126 may include a stereoscopic camera assembly that may determine depth information of the imaged environment. The stereoscopic camera assembly may include at least a pair of imaging devices that are separated by a known distance from each other, and a stereoscopic camera controller. The stereoscopic camera controller receives images of an environment generated by each imaging device of the pair of imaging devices, and generates depth information of the imaged environment based on image disparity computations performed with respect to the images from each imaging device of the pair of imaging devices.

In some embodiments, the camera sub-system 126 may include a depth camera assembly that may determine depth information of the surrounding environment by actively illuminating the environment with a light pattern. The camera sub-system 126 may include a light generator, an imaging device, and a depth camera controller that may be coupled to both the light generator and the imaging device. The light generator illuminates a local area with illumination light, e.g., in accordance with emission instructions generated by the depth camera controller. The depth camera controller is configured to control, based on the emission instructions, operation of certain components of the light generator, e.g., to adjust an intensity and a pattern of the illumination light illuminating the local area. In some embodiments, the illumination light may include a structured light pattern, e.g., dot pattern, line pattern, etc. The imaging device captures one or more images of one or more objects in the local area illuminated with the illumination light. The depth camera controller may compute the depth information, using the image data captured by the imaging device, e.g., time of flight or other image processing techniques on the emitted structured light.

In some embodiments, the camera sub-system 126 may include a visual motion camera assembly that may determine depth information of the imaged environment. The visual motion camera assembly may include an imaging device and a visual motion camera controller. The visual motion camera controller receives temporal images of the environment as captured by the imaging device, and generates motion and depth information of the imaged environment based on optic flow computations performed with respect to the temporal images.

In some embodiments, the camera sub-system 126 may include an imaging device and a visual information analysis module that may determine depth information of objects in the imaged environment. The visual information analysis assembly may determine the depth of objects based on predefined size information of expected objects in the field of view of the imaging device. For example, the predefined size information of a typical adult human may be specified to lie in a range of 5-6 ft, which may correspond to an image of the human spanning a particular range of pixels in the image data based on the distance of location of the human, the resolution of the image, etc. Other predefined anthropomorphic feature sizes or size ratios may also be predefined to determine the depth information for a human imaged in the environment. In addition to obtaining the depth information based on predefined size information of objects in the environment, the azimuthal information regarding the location of these objects may be obtained by generating a target bounding box for the imaged object, estimating a pixel distance of the bounding box from a center of the image, and correlating the pixel distance to predefined size information with respect to the image resolution.

The camera sub-system 126 computes location information based on the depth information. The camera sub-system 126 may combine the computed location information with human detection or recognition results to provide location information of one or more target individuals within the environment to an audio equalization module 158.

The network interface 128 facilitates connection of the communication system 120 to the network 110. For example, the network interface 128 may include software and/or hardware that facilitates communication of voice, video, and/or other data signals with one or more client devices 115 to enable voice and video calls or other operation of various applications executing on the communication system 120. The network interface 128 may operate according to any conventional wired or wireless communication protocols that enable it to communication over the network 110.

The display sub-system 160 comprises an electronic device or an interface to an electronic device for presenting images or video content. For example, the display sub-system 160 may comprises an LED display panel, an LCD display panel, a projector, a virtual reality headset, an augmented reality headset, another type of display device, or an interface for connecting to any of the above-described display devices. In an embodiment, the display sub-system 160 includes a display that is integrated with other components of the communication system 120. Alternatively, the display sub-system 160 comprises one or more ports (e.g., an HDMI port) that couples the communication system to an external display device (e.g., a television).

The audio output sub-system 170 comprises one or more speakers or an interface for coupling to one or more external speakers that generate ambient audio based on received audio signals. In an embodiment, the audio output sub-system 170 includes one or more speakers integrated with other components of the communication system 120. Alternatively, the audio output sub-system 170 comprises an interface (e.g., an HDMI interface or optical interface) for coupling the communication system 120 with one or more external speakers (for example, a dedicated speaker system or television). The audio output sub-system 170 may output audio in multiple channels to generate beamformed audio signals that give the listener a sense of directionality associated with the audio. For example, the audio output sub-system 170 may generate audio output as a stereo audio output or a multi-channel audio output such as 2.1, 3.1, 5.1, 7.1, or any other standard configuration.

In embodiments in which the communication system 120 is coupled to an external media device such as a television, the communication system 120 may lack an integrated display and/or an integrated speaker, and may instead only communicate audio/visual data for outputting via a display and speaker system of the external media device.

The processor 130 operates in conjunction with the storage medium 150 (e.g., a non-transitory computer-readable storage medium) to carry out various functions attributed to the communication system 120 described herein. For example, the storage medium 150 may store one or more modules or applications (e.g., user interface 152, communication module 154, user applications 156) embodied as instructions executable by the processor 130. The instructions, when executed by the processor, cause the processor 130 to carry out the functions attributed to the various modules or applications described herein. In an embodiment, the processor 130 may comprise a single processor or a multi-processor system.

In an embodiment, the storage medium 150 comprises a user interface module 152, a communication module 154, user applications 156. In alternative embodiments, the storage medium 150 may comprise different or additional components.

The user interface module 152 comprises visual and/or audio elements and controls for enabling user interaction with the communication system 120. For example, the user interface module 152 may receive inputs from the user input device 122 to enable the user to select various functions of the communication system 120. In an example embodiment, the user interface module 152 includes a calling interface to enable the communication system 120 to make or receive voice and/or video calls over the network 110. To make a call, the user interface module 152 may provide controls to enable a user to select one or more contacts for calling, to initiate the call, to control various functions during the call, and to end the call. To receive a call, the user interface module 152 may provide controls to enable a user to accept an incoming call, to control various functions during the call, and to end the call. For video calls, the user interface module 152 may include a video call interface that displays remote video from a client 115 together with various control elements such as volume control, an end call control, or various controls relating to how the received video is displayed or the received audio is outputted.

The user interface module 152 may furthermore enable a user to access user applications 156 or to control various settings of the communication system 120. In an embodiment, the user interface module 152 may enable customization of the user interface according to user preferences. Here, the user interface module 152 may store different preferences for different users of the communication system 120 and may adjust settings depending on the current user.

The communication module 154 facilitates communications of the communication system 120 with clients 115 for voice and/or video calls. For example, the communication module 154 may maintain a directory of contacts and facilitate connections to those contacts in response to commands from the user interface module 152 to initiate a call. Furthermore, the communication module 154 may receive indications of incoming calls and interact with the user interface module 152 to facilitate reception of the incoming call. The communication module 154 may furthermore process incoming and outgoing voice and/or video signals during calls to maintain a robust connection and to facilitate various in-call functions.

The user applications 156 comprise one or more applications that may be accessible by a user via the user interface module 152 to facilitate various functions of the communication system 120. For example, the user applications 156 may include a web browser for browsing web pages on the Internet, a picture viewer for viewing images, a media playback system for playing video or audio files, an intelligent virtual assistant for performing various tasks or services in response to user requests, or other applications for performing various functions. In an embodiment, the user applications 156 includes a social networking application that enables integration of the communication system 120 with a user's social networking account. Here, for example, the communication system 120 may obtain various information from the user's social networking account to facilitate a more personalized user experience. Furthermore, the communication system 120 can enable the user to directly interact with the social network by viewing or creating posts, accessing feeds, interacting with friends, etc. Additionally, based on the user preferences, the social networking application may facilitate retrieval of various alerts or notifications that may be of interest to the user relating to activity on the social network. In an embodiment, users may add or remove applications 156 to customize operation of the communication system 120.

The audio equalization module 158 receives audio signals that are intended for audio playback, and dynamically modifies the audio signals to generate equalized audio signals that are subsequently provided to the audio output sub-system 170 for output by speakers. The dynamically modified audio signals are generated by applying an equalization function to the audio signals. Generating equalized audio signals prior to being output by the audio output sub-system 170 ensures that the audio quality is maintained during audio playback from the perspective of the listener, e.g., in view of placement characteristics of the communication system 120, as the target user of the communication system 120 moves about the surrounding environment, as a layout of the surrounding environment changes, acoustic characteristics of the communication system 120 such as audio playback volume, based on the identification of the target user, based on the number of target users within the environment, their locations and positions, distances and azimuths, etc., and any combination thereof

In some embodiments, the communication server 105 in FIG. 1 may collect empirical data such as local environment-related information, position information of target users, client device audio playback volume adjustment information, etc., gathered at some of the client devices, e.g., 115A and 115B in FIG. 1. The communication server 105 may generate the equalization function with specified equalization parameters based on the collected data as empirical or analytical functions of a determined target position to apply to audio signals in order to compensate for an expected loss in audio signals between a client device and a determined target position. The equalization parameters may be based on various factors, including the target position, audio playback volume, frequency characteristics of the audio signals, and environmental characteristics where a client device may be located, etc. In some embodiments, the communication server 105 may use the empirical user information to train machine learning and/or deep learning models, such as regression models, reinforcement models, or neural networks to generate an equalization function with specified equalization parameters based on the target position including distance and azimuth, target audio playback volume, frequency characteristics of the audio signal, and environmental characteristics where a client device may be located. The communication server 105 may provide the generated equalization function with specified equalization parameters to the communication system 120 for storage. In some embodiments, the communication server 105 may also generate and provide one or more look-up tables based on the equalization function and specified equalization parameters to the communication system 120 for storage.

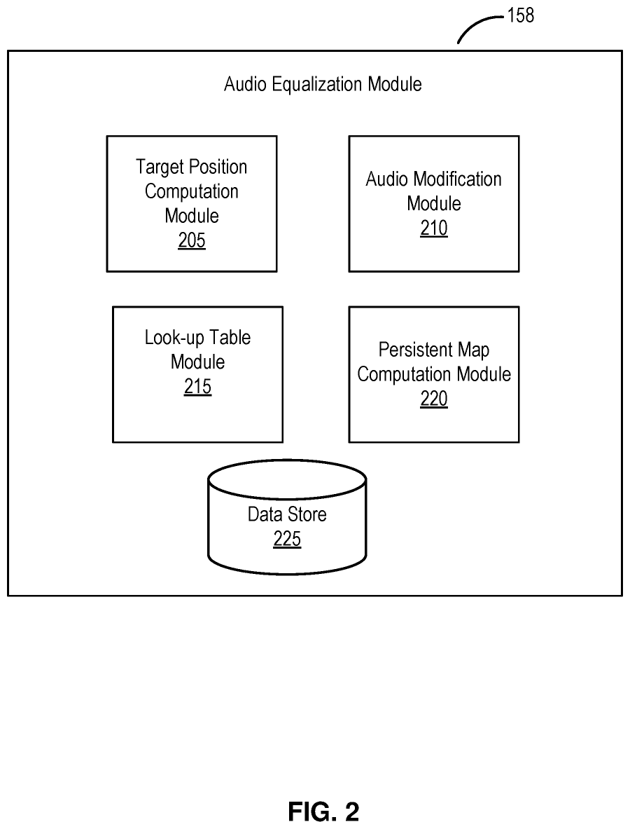

FIG. 2 is a block diagram of an audio equalization module 158, in accordance with an embodiment. The audio equalization module 158 includes a target position computation module 205, an audio modification module 210, a look-up table module 215, a persistent map computation module 220, and a data store 225. In alternative configurations, the audio equalization module 158 may include different and/or additional modules.

The target position computation module 205 establishes a target position that is subsequently used by the audio modification module 210 for generating the equalized audio signal. The target position computation module 205 receives the locations of one or more target individuals in the three-dimensional (3D) space of the environment from the sensors of the camera sub-system 126 and/or proximity sensors, such as sensors based on microwave, radio, sound, ultrasound, etc., located in the communication system 120, and computes the target position based on the received locations of the one or more target individuals. A location for a target individual may be a distance of the target individual from the client device, and an azimuthal angle made by the location of the target individual with respect to a known reference listening direction from the client device. When the target position computation module 205 receives the location of just one target individual from the camera sub-system 126, the established target position may be the location of the one target individual. When the target position computation module 205 receives the locations of multiple target individuals from the camera sub-system 126, the established target position may be determined based on a combination of the locations of the multiple target individuals. The established target position may be any of: an estimated location of a center of mass of the locations of the multiple target individuals or a weighted combination of the locations of the multiple target individuals, etc. The weighted combination may involve weights that are based on any of: captured audio signals received from the microphone sub-system 124, a distance of the target individuals from the client device, the azimuthal angle made by the locations of target individuals, pre-specified rankings of at least some identified target individuals, or some combination thereof. When the target position computation module 205 does not receive 3D location information associated with any target individual in the environment, such as, for example, when no target individual is identified by the camera sub-system 126, the module 205 may provide a default target position and/or an indication to the audio modification module 210 that there is no located target individual.

The audio modification module 210 receives an audio signal that is intended for playback by the audio output subsystem 170 and generates an equalized audio signal that is subsequently provided to the audio output sub-system 170 for audio playback. Generating the equalized audio signal involves applying a complex frequency-dependent gain function to the received audio signal. The complex frequency-dependent gain function, also called the equalization function, is parameterized by a set of equalization parameters. The set of equalization parameters to be applied to the audio signal is based on the target position that is received from the target position computation module 205. The equalization parameters may be based on other factors, including, for e.g., a target audio playback volume. The audio modification module 210 obtains the equalization parameters based on the received target position, computes the equalization function based on these obtained equalization parameters and applies the equalization function to the audio signals so that the audio quality is maintained during audio playback for the one or more target individuals in the environment. The audio modification module 210 applies the equalization function to the audio signal dynamically, in real time, to compensate for estimated losses that occur between the communication system 120 and the target position such that the audio signal received at the target position is similar to uncompensated audio that would be heard at a reference location in front of the communication system 120. The equalization function that is applied to the audio signal may cause a boost or reduction in the amplitude for certain frequency components in the audio signal and/or apply a phase shift to some of the frequency components of the audio signal. The audio modification module 210 provides the equalized audio signal to the audio output sub-system 170 for output by the speakers.

In some embodiments, the audio modification module 210 may obtain the equalization parameters from a look-up table stored in the data store 225. The look-up table maps target positions to predefined sets of equalization parameters. In some embodiments, the look-up table values may be fixed and independent of the environment of the communication system 120, i.e., they may be based on an approximation of a typical environment, with predefined values that map the target position to the equalization parameters in a way that, when applied, the equalization will substantially compensate for signal losses that occur between the communication system 120 and the target position. Alternatively, the look-up table values may be computed based on sensed information about a particular environment in which the communication system 120 is located, such that the equalization parameters may depend on factors such as a size of the room, locations of objects in the room, or other characteristics affecting audio in the room. For example, the look-up table values may be based on a persistent map of the environment that is generated by the persistent map computation module 220, as will be described in further detail below. The persistent map of the environment provides a spatial 3D persistent representation of the environment, including a volumetric grid representation of 3D positions that may be occupied by a target individual within the environment. The look-up table values may map the equalization parameters to positions in the volumetric grid. In yet another embodiment, the audio modification module 210 may generate the equalized audio signal by performing a real-time computation of a function that maps the target position to the equalization parameters. The real-time computation of the equalization parameters may be based on properties of the audio signal, stored information about the environment in the data store 225, stored user information, etc., or some combination thereof. The audio modification module 210 may retrieve the stored information about the environment and users from the data store 225. In some embodiments, the audio modification module 210 may use the retrieved environment information to account for the presence of absorbent and reflecting surfaces in the environment while determining the equalization parameters. In some embodiments, when generating the equalized audio signal, the audio modification module 210 may dynamically modify the values retrieved from the function or the look-up table based on prior user behavior. In these embodiments, the audio modification module 210 may also receive information regarding one or more identified target individuals from the camera sub-system 126. The audio modification module 210 may retrieve prior user behavior information that is stored for the set of identified target users of the communication system 120 in the data store 225 to generate the modified audio signals for the identified one or more target individuals. The stored prior user behavior may include preferred audio settings of specific target users, possibly as a function of the position information of the specific target users.

The look-up table module 215 generates and/or maintains one or more look-up tables of equalization parameter values. The module 215 populates each generated look-up table with equalization parameter values indexed by target position values in the environment. The look-up table module 215 may receive the equalization function and specified equalization parameters from the communication server 105 and store the received function and specified equalization parameters at the data store 225 to generate the look-up tables. The look-up table module 215 may generate the look-up tables based on the stored specified equalization parameters at the data store 225. The look-up table module 215 may modify the received specified equalization parameters based on the environmental characteristics surrounding the communication system 120 and/or specific identified target user characteristics that are stored on the data store 225 to generate the one or more look-up tables. The generated look-up tables may be fixed once generated, or they may be modified periodically based on modifications made to a persistent map of the environment. The look-up table module 215 may also periodically modify the one or more look-up tables based on updated user and environmental characteristics.

The persistent map computation module 220 generates a map of the environment that includes the persistent objects of the environment such as stationary and static objects like doors, windows, furniture, etc., rather than dynamic, temporary, moving objects, such as a target user or a pet, etc. The module 220 may generate the persistent map of the environment from sensor data that is received from one or more sensors of the client device, e.g., the sensors of the camera sub-system 126 and/or a proximity sensor, such as sensors based on microwave, radio, sound, ultrasound, etc., located in the communication system 120. The module 220 may obtain images of the environment periodically (e.g., daily, weekly, monthly, etc.), or as configured by a user of the client device from the camera sub-system 126. The persistent map computation module 220 may employ a variety of image processing techniques on the image data, such as feature extraction, image segmentation, classification, object identification, etc. to generate the map. The module 220 pre-processes the image data to generate and store the persistent map in the data store 225 in advance of audio equalization. The pre-processing of the image data may provide information such as the presence of absorbent and reflecting surfaces in the environment, which is then incorporated into the generated one or more persistent maps of the environment. In one embodiment, multiple persistent maps of the environment may be generated and stitched together to form a composite map of the environment that includes the persistent objects of the environment. The composite map of the environment is also referred to as the persistent map of the environment. The persistent map of the environment may be a 3D representation of the environment that is represented by a volumetric grid of positions that may be occupied by a target individual within the environment. The persistent map computation module 215 may periodically update the stored persistent map based on determined changes in the environment or with respect to the users of the communication system 120.

The data store 225 is a memory, such as a read only memory (ROM), dynamic random-access memory (DRAM), static random-access memory (SRAM), or some combination thereof. The data store 225 stores information for the audio equalization module 158. The stored information may include audio-related user preference information, one or more look-up tables for determining the gain, a pre-computed persistent map of the environment, etc. The data store 225 may store audio-related user preference and profile information that is gathered by various modules of the communication system 120, and include preferred audio settings for various preferred audio data for specific target users of the communication system 120. Preferred audio settings may include information such as the desired equalization parameter values, spatial rendering attributes, etc. The data store 225 may receive the one or more look-up tables from the communication server 105. In some embodiments, the data store 225 may store a pre-computed persistent map of the environment that is generated by and received from persistent map computation module 220. The data store 225 may also store one or more look-up tables that are generated by the look-up table module based on the persistent map of the environment that is generated by the persistent map computation module 220.

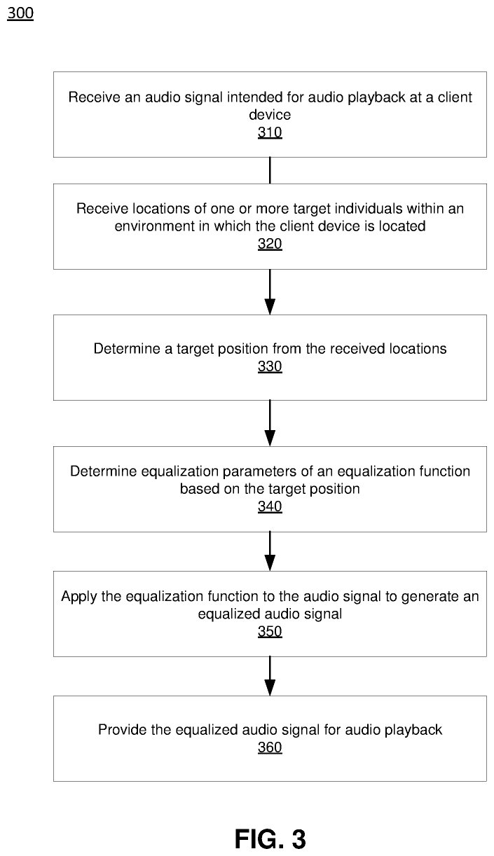

FIG. 3 is a flowchart illustrating a process 300 for performing audio equalization at a client device, in accordance with an embodiment. In one embodiment, the process of FIG. 3 is performed by the audio equalization module 158 of FIG. 1 and the modules depicted in FIG. 2. The process 300 may include different or additional steps than those described in conjunction with FIG. 3 or in different orders than the order described in conjunction with FIG. 3.

The audio equalization module 158 receives 310 an audio signal that is intended for audio playback by the audio output sub-system 170. The audio output sub-system may select speakers that are located either internal to or external to the client device for performing the audio playback.

The audio equalization module 158 receives 320 locations of one or more target individuals within the environment in which the client device is located. The locations of the one or more target individuals are received from the camera sub-system 126 based on sensor data that is received from one or more sensors of the client device, e.g., the sensors of the camera sub-system 126 and/or a proximity sensor, such as sensors based on microwave, radio, sound, ultrasound, etc., located in the client device. The received locations include a distance of each of the one or more target individuals from the client device and an azimuthal angle made by each of the one or more target individuals with respect to a reference listening direction for the client device.

The audio equalization module 158 determines 330 a target position based on the received locations of the one or more target individuals. In some embodiments, the audio equalization module 158 determines a target position as a weighted combination of the received distances and azimuthal angles of each of the one or more target individuals.

The audio equalization module 158 determines 340 equalization parameters of the equalization function that is to be applied to the received audio signal. The module 158 determines these parameters based on the determined target position or other criteria (e.g., target audio volume) from any of: the one or more look-up tables stored in the data store 225, from a real-time computation based on properties of the audio signal, or from a combination thereof. The audio equalization module 158 generates the equalization function by computing a frequency dependent complex gain function based on the determined equalization parameters.

The audio equalization module 158 applies 350 the equalization function to the received audio signal to generate the equalized audio signal by applying the frequency dependent complex gain function to the received audio signal to compensate for an expected loss in the audio signal between the client device and the determined target position.

The audio equalization module 158 provides the equalized audio signal to the audio output sub-system 170 for audio playback.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
receiving an audio signal intended for audio playback by a client device;
receiving locations of one or more target individuals within an environment in which the client device is located;
determining a target position based on the received locations of the one or more target individuals;
determining, based on the target position, equalization parameters of an equalization function by retrieving the equalization parameters from stored one or more look-up tables based on the determined target position, wherein the stored one or more look-up tables are based on a stored persistent map of the environment, the persistent map of the environment including one or more persistent objects of the environment rather than one or more dynamic or temporary or moving objects;
applying the equalization function to the received audio signal to generate an equalized audio signal based on the determined equalization parameters;
providing the equalized audio signal for audio playback to an audio output system of the client device; and
the method further comprising:
periodically updating the stored persistent map of the environment and
modifying the stored one or more look-up tables based on the updated persistent map.

2. The method of claim 1, wherein the locations of the one or more target individuals is determined from sensor data provided by one or more sensors on the client device.

3. The method of claim 1, wherein receiving the locations of the one or more target individuals within the environment in which the client device is located comprises:
receiving a distance of each of the one or more target individuals from the client device; and
receiving an azimuthal angle made by each of the one or more target individuals with respect to a reference listening direction for the client device.

4. The method of claim 3, wherein determining a target position based on the received locations of the one or more target individuals comprises:
generating the target position as a weighted combination of the received distances and azimuthal angles of each of the one or more target individuals.

5. The method of claim 1, wherein
the stored one or more look-up tables provide a frequency-dependent mapping of target positions to the equalization parameters.

6. The method of claim 1, wherein applying the equalization function to the received audio signal to generate the equalized audio signal comprises:
computing the equalization function based on the determined equalization parameters; and
generating the equalized audio signal by applying the computed equalization function to the received audio signal.

7. The method of claim 1, wherein applying the equalization function to the received audio signal to generate an equalized audio signal based on the determined equalization parameters comprises:
computing a frequency dependent complex gain function based on the determined equalization parameters; and applying the frequency dependent complex gain function to the received audio signal to compensate for an expected loss in the audio signal between the client device and the determined target position.

8. The method of claim 1, wherein the equalization parameters of the equalization function may be based on one or more of:
empirical user information; and
a prior history of user behavior.

9. The method of claim 1,
wherein the persistent map of the environment is generated by:
receiving sensor data of the environment over a period of time from one or more sensors in the client device;
pre-processing the sensor data to generate the persistent map of the environment; and
storing the generated persistent map of the environment; and
wherein periodically updating the stored persistent map of the environment is based on periodic pre-processing of image data of the environment.

10. (canceled)

11. A non-transitory computer-readable medium comprising computer program instructions that, when executed by a computer processor of an online system, cause the processor to perform steps comprising:
receiving an audio signal intended for audio playback by a client device;
receiving locations of one or more target individuals within an environment in which the client device is located;
determining a target position based on the received locations of the one or more target individuals;
determining, based on the target position, equalization parameters of an equalization function by retrieving the equalization parameters from stored one or more look-up tables based on the determined target position, wherein the stored one or more look-up tables are based on a stored persistent map of the environment, the persistent map of the environment including one or more persistent objects of the environment rather than one or more dynamic or temporary or moving objects;
applying the equalization function to the received audio signal to generate an equalized audio signal based on the determined equalization parameters;
providing the equalized audio signal for audio playback to an audio output system of the client device; and
the method further comprising:
periodically updating the stored persistent map of the environment and
modifying the stored one or more look-up tables based on the updated persistent map.

12. The non-transitory computer-readable medium of claim 11, wherein the locations of the one or more target individuals is determined from sensor data provided by one or more sensors on the client device.

13. The non-transitory computer-readable medium of claim 11, wherein receiving the locations of the one or more target individuals within the environment in which the client device is located comprises:
receiving a distance of each of the one or more target individuals from the client device; and
receiving an azimuthal angle made by each of the one or more target individuals with respect to a reference listening direction for the client device.

14. The non-transitory computer-readable medium of claim 13, wherein determining a target position based on the received locations of the one or more target individuals comprises:
generating the target position as a weighted combination of the received distances and azimuthal angles of each of the one or more target individuals.

15. The non-transitory computer-readable medium of claim 11, wherein
the stored one or more look-up tables provide a frequency-dependent mapping of target positions to the equalization parameters.

16. The non-transitory computer-readable medium of claim 11, wherein applying the equalization function to the received audio signal to generate the equalized audio signal comprises:
computing the equalization function based on the determined equalization parameters; and
generating the equalized audio signal by applying the computed equalization function to the received audio signal.

17. A system comprising:
a processor; and
a non-transitory computer-readable medium comprising computer program instructions that when executed by the processor of an online system causes the processor to perform steps comprising:
receiving an audio signal intended for audio playback by a client device;
receiving locations of one or more target individuals within an environment in which the client device is located;
determining a target position based on the received locations of the one or more target individuals;
determining, based on the target position, equalization parameters of an equalization function by retrieving the equalization parameters from stored one or more look-up tables based on the determined target position, wherein the stored one or more look-up tables are based on a stored persistent map of the environment, the persistent map of the environment including one or more persistent objects of the environment rather than one or more dynamic or temporary or moving objects;
applying the equalization function to the received audio signal to generate an equalized audio signal based on the determined equalization parameters;
providing the equalized audio signal for audio playback to an audio output system of the client device; and
the method further comprising:
periodically updating the stored persistent map of the environment and
modifying the stored one or more look-up tables based on the updated persistent map.

18. The system of claim 17, wherein the locations of the one or more target individuals is determined from sensor data provided by one or more sensors on the client device.

19. The system of claim 17, wherein
the stored one or more look-up tables provide a frequency-dependent mapping of target positions to the equalization parameters.

20. The system of claim 17, wherein applying the equalization function to the received audio signal to generate the equalized audio signal comprises:
computing the equalization function based on the determined equalization parameters; and
generating the equalized audio signal by applying the computed equalization function to the received audio signal.
